(19) United States
(12) Patent Application Publication
(10) Pub. No.: US 2014/0239704 A1
(43) Pub. Date: Aug. 28, 2014

(54) Reversible Wheel and Methods of Making and Using the Same

(71) Applicants: Scotty Vann Bass, Hartsfield, GA (US); Roscoe Herbert Prosser, Thomasville, GA (US)

(72) Inventors: Scotty Vann Bass, Hartsfield, GA (US); Roscoe Herbert Prosser, Thomasville, GA (US)

(21) Appl. No.: 13/779,868

(22) Filed: Feb. 28, 2013

(51) Int. Cl. B60B 3/08; B23P 15/00

(52) U.S. Cl. CPC B60B 3/085; B23P 15/00
USPC 301/64.303; 301/64.302; 29/894.3; 29/426.2

(57) ABSTRACT

Reversible wheels are disclosed. Methods of making and using reversible wheels are further disclosed.

### FIELD OF THE INVENTION

This invention generally relates to reversible wheels. This invention also relates to methods of making reversible wheels, as well as methods of using reversible wheels.

### BACKGROUND

In oval track racing, tires wear more on the left side of the tire than on the right side. To cut tire cost, most racers take the tire off the wheel and turn it around, race it 3-5 races, take it off, turn it around 3-5 more races, and continue to repeat this procedure until the tire is completely worn out all the way across the tire.

Efforts continue to further develop wheels so as to minimize the time and effort needed to utilize the wear across a tire.

### SUMMARY OF THE INVENTION

The present invention is directed to reversible wheels. In one exemplary embodiment, the reversible wheel comprises two lug bolt plates spaced from one another, each of the two lug bolt plates independently comprising two or more lug bolt holes.

In another exemplary embodiment, the reversible wheel comprises two lug bolt plates spaced from one another, each of the two lug bolt plates independently comprising three or more lug bolt holes; and a wheel rim integrally connected to the two lug bolt plates, the wheel rim comprising an outer rim surface extending from a first rim end to a second rim end opposite the first rim end, wherein a first lug bolt plate of the two lug bolt plates is positioned a first distance from the first end and a second lug bolt plate of the two lug bolt plates is positioned a second distance from the second end, and the first and second distances are substantially equal.

The present invention is further directed to reversible wheels in combination with a tire. In one exemplary embodiment, the reversible wheel/tire combination comprises two lug bolt plates spaced from one another, each of the two lug bolt plates independently comprising three or more lug bolt holes; a wheel rim integrally connected to the two lug bolt plates, the wheel rim comprising an outer rim surface extending from a first rim end to a second rim end opposite the first rim end; and a tire extending along and over at least a portion of said outer rim surface.

The present invention is also directed to methods of making reversible wheels. In one exemplary embodiment, the method of making a reversible wheel of the present invention comprises forming a wheel comprising two lug bolt plates spaced from one another. The methods of making reversible wheels of the present invention may further include one or more additional method steps. Suitable method steps include, but are not limited to, molding one or more wheel components during a thermoforming step (e.g., an injection molding step or a metal-shaping step); molding two or more separate wheel components during a thermoforming step (e.g., an injection molding step or a metal-shaping step); connecting two or more separate wheel components to one another; a welding step; drilling two or more lug bolt holes in each lug bolt plate; cutting one or more cut-out sections through each lug bolt plate, wherein the one or more cut-out sections of each lug nut plate provide tool access to lug bolt holes on an adjacent lug bolt plate; or any combination thereof.

The present invention is even further directed to methods of using reversible wheels. In one exemplary embodiment, the method of using a reversible wheel comprises attaching the reversible wheel to a vehicle via one or more lug bolts and one of the two lug bolt plates that is closest to the vehicle. In another exemplary embodiment, the method of using a reversible wheel comprises removing the reversible wheel from a vehicle by unscrewing one or more lug bolts attached to a first lug bolt plate of the two lug bolt plates; and re-attaching the reversible wheel to the vehicle via one or more lug bolts and a second lug bolt plate of the two lug bolt plates.

These and other features and advantages of the present invention will become apparent after a review of the following detailed description of the disclosed embodiments and the appended claims.

### BRIEF DESCRIPTION OF DRAWINGS

The invention may be more completely understood and appreciated in consideration of the following detailed description of various embodiments of the invention in connection with the accompanying drawings, in which:

FIG. 1 is a perspective view of an exemplary reversible wheel of the present invention;

FIG. 2 is a side view (or a top view or a bottom view) of the exemplary reversible wheel shown in FIG. 1;

FIG. 3 is view of the exemplary reversible wheel shown in FIG. 1 or 2 as viewed from a left side of the exemplary reversible wheel;

FIG. 4 is a view of the exemplary reversible wheel shown in FIG. 1 or 2 as viewed from a right side of the exemplary reversible wheel;

FIG. 5 is a cross-sectional view of the reversible wheel shown in FIG. 4 as viewed along line 5-5 shown in FIG. 4;

FIG. 6 is an exploded view of an outer surface at one end of the reversible wheel shown in FIG. 2; and

FIG. 7 depicts an exemplary reversible wheel/tire combination comprising the exemplary reversible wheel shown in FIG. 1.

In the specification, a same reference numeral used in multiple figures refers to the same or similar elements having the same or similar properties and functionalities.

### DETAILED DESCRIPTION

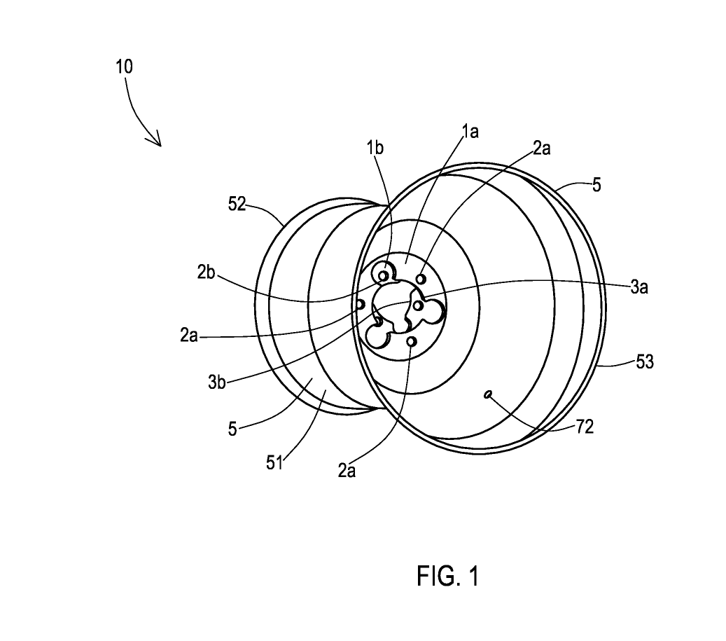

The present invention is directed to reversible wheels such as exemplary reversible wheel 10 shown in FIG. 1. The present invention is further directed to methods of making and using reversible wheels such as exemplary reversible wheel 10 shown in FIG. 1. As shown in FIG. 1, exemplary reversible wheel 10 comprises two lug bolt plates 1a and 1b spaced from one another (both of which are shown in solid lines in the figures). As shown in FIG. 1, exemplary reversible wheel 10 shows lug bolt plate 1a in front of and spaced from lug bolt plate 1b. Each of lug bolt plates 1a and 1b independently comprises one or more lug bolt holes 2a and 2b. Typically, each of lug bolt plates 1a and 1b independently comprises two or more lug bolt holes 2a and 2b.

Exemplary reversible wheel 10 also comprises a wheel rim 5 (shown in dashed lines in the figures) integrally connected to two lug bolt plates 1a and 1b. Wheel rim 5 comprises an outer rim surface 51 extending from a first rim end 53 to a second rim end 52 opposite first rim end 53. Wheel rim 5 may have any desired size, shape, and/or configuration.

The present invention is further directed to methods of making reversible wheels such as exemplary reversible wheel 10. As discussed above, in one exemplary embodiment, the method of making a reversible wheel of the present invention comprises forming a wheel 10 comprising two lug bolt plates 1a and 1b spaced from one another (as shown in the figures). Methods of making reversible wheels 10 of the present invention may further comprise one or more additional steps including, but not limited to, molding one or more wheel components during a thermoforming step (e.g., an injection molding step or a metal-shaping step); molding two or more separate wheel components during a thermoforming step (e.g., an injection molding step or a metal-shaping step); connecting two or more separate wheel components to one another; a welding step; drilling two or more lug bolt holes in each lug bolt plate; cutting one or more cut-out sections through each lug bolt plate, wherein the one or more cut-out sections of each lug nut plate provide tool access to lug bolt holes on an adjacent lug bolt plate; or any combination thereof.

The present invention is even further directed to methods of using reversible wheels such as exemplary reversible wheel 10. As discussed above, in one exemplary embodiment, the method of using a reversible wheel 10 comprises attaching the reversible wheel 10 to a vehicle (not shown) via one or more lug bolts 4a and/or 4b and one of the two lug bolt plates 1a or 1b that is closest to the vehicle. In another exemplary embodiment, the method of using a reversible wheel 10 comprises removing the reversible wheel 10 from a vehicle (not shown) by unscrewing one or more lug bolts 4a attached to a first lug bolt plate 1a of the two lug bolt plates 1a and 1b; and re-attaching the reversible wheel 10 to the vehicle via one or more lug bolts 4b and a second lug bolt plate 1b of the two lug bolt plates 1a and 1b.

### ADDITIONAL EMBODIMENTS

### Reversible Wheel Embodiments

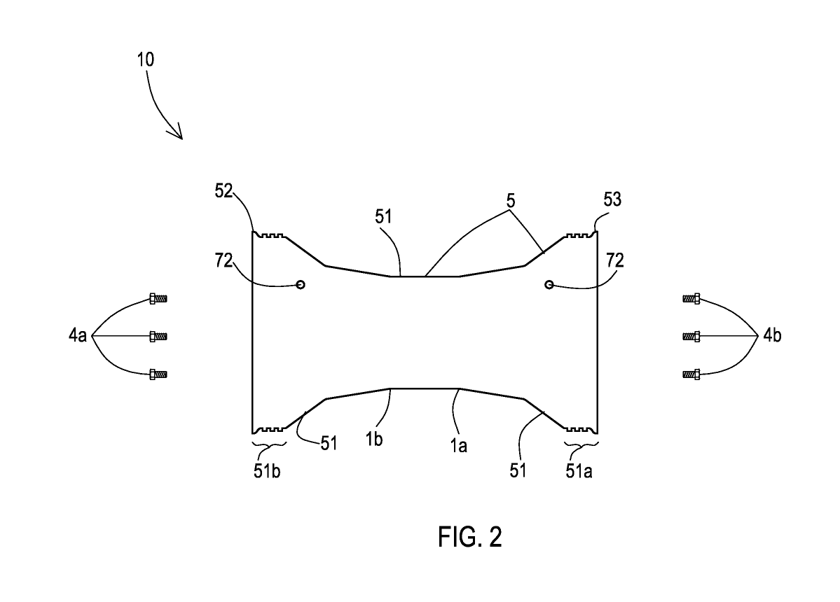

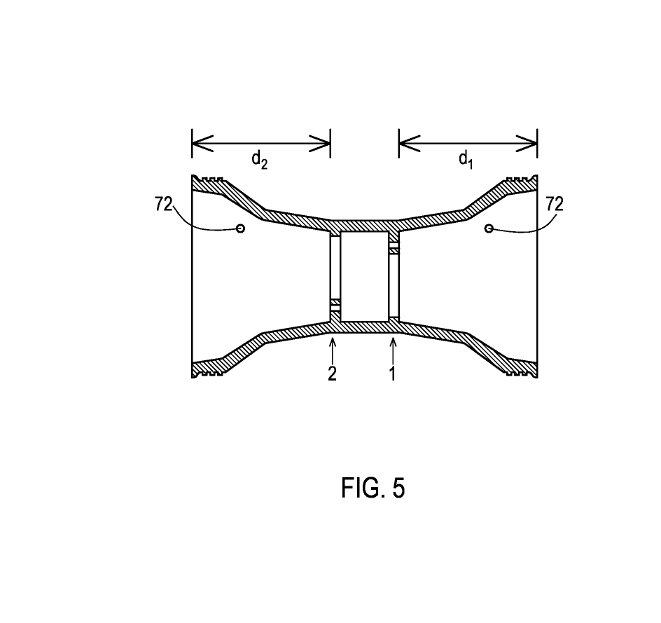

1. A reversible wheel 10 comprising: two lug bolt plates 1a and 1b spaced from one another, each of said two lug bolt plates 1a and 1b independently comprising two or more lug bolt holes 2a and 2b. For example, lug bolt plates 1a and 1b may be spaced from one another by from about 1.0 inches (in) (2.54 centimeters (cm)) to about 12.0 in (30.5 cm), or any value therebetween or range of values therebetween, in increments of 0.01 in (0.0254 cm).
2. The reversible wheel 10 of embodiment 1, wherein each of said two lug bolt plates 1a and 1b independently comprises three lug bolt holes 2a and 2b. In other embodiments, each of said two lug bolt plates 1a and 1b independently comprises from 2 to about 12 lug bolt holes 2a and 2b, or any number or range of numbers between 2 and 12.
3. The reversible wheel 10 of embodiment 1 or 2, wherein each of said two lug bolt plates 1a and 1b independently comprises one or more cut-out sections 3a and 3b so as to provide tool access to said two or more lug bolt holes 2a and 2b on a given lug bolt plate 1a or 1b. As used herein, the phrase “tool access” is used to describe spacing that enables a tool such as a wrench (not shown) to be positioned near and/or come into contact with the two or more lug bolt holes 2a and 2b on a given lug bolt plate 1a or 1b. Typically, each of said two lug bolt plates 1a and 1b independently comprises a single cut-out section 3a and 3b, but each of said two lug bolt plates 1a and 1b may independently comprise any number of cut-out section 3a and 3b up to about the number of lug bolt holes 2a or 2b on a given lug bolt plate 1a or 1b (e.g., up to about 12, or any number between 1 and 12).
4. The reversible wheel 10 of any one of embodiments 1 to 3, wherein each of said two lug bolt plates 1a and 1b independently comprises a single cut-out section 3a and 3b so as to provide tool access to said two or more lug bolt holes 2a and 2b on a given lug bolt plate 1a or 1b.
5. The reversible wheel 10 of any one of embodiments 1 to 4, wherein each of said two lug bolt plates 1a and 1b independently comprises a single cut-out section 3a and 3b so as to provide tool access to said two or more lug bolt holes 2a and 2b on a given lug bolt plate 1a or 1b, said single cut-out section 3a and 3b having a symmetrical three-petal clover shape. It should be understood that when each of said two lug bolt plates 1a and 1b independently comprises a single cut-out section 3a and 3b, each single cut-out section 3a and 3b may have any desired shape as long as the cut-out section provides tool access to the lug bolt holes 2a or 2b on an adjacent lug bolt plate 1a or 1b.
6. The reversible wheel 10 of any one of embodiments 1 to 5, wherein each of said two lug bolt plates 1a and 1b independently comprises a single cut-out section 3a and 3b so as to provide tool access to said two or more lug bolt holes 2a and 2b on a given lug bolt plate 1a or 1b, wherein said single cut-out section 3a and 3b is sized so as to enable positioning of an impact gun component (not shown) or a ratchet wrench component (not shown) thru a first lug bolt plate 1a of said two lug bolt plates 1a and 1b so as to (i) remove lug nuts 4b (see, FIG. 2) from or (ii) secure lug nuts 4b to a second lug bolt plate 1b of said two lug bolt plates 1a and 1b.
7. The reversible wheel 10 of any one of embodiments 1 to 6, further comprising a wheel rim 5 integrally connected to said two lug bolt plates 1a and 1b, said wheel rim 5 comprising an outer rim surface 51 extending from a first rim end 53 to a second rim end 52 opposite said first rim end 53.
8. The reversible wheel 10 of any one of embodiments 1 to 7, further comprising a wheel rim 5 integrally connected to said two lug bolt plates 1a and 1b, said wheel rim 5 comprising an outer rim surface 51 extending from a first rim end 53 to a second rim end 52 opposite said first rim end 53, wherein a first lug bolt plate 1a of said two lug bolt plates 1a and 1b is positioned a first distance d₁ (see, FIG. 5) from said first rim end 53 and a second lug bolt plate 1b of said two lug bolt plates 1a and 1b is positioned a second distance d₂ (see, FIG. 5) from said second rim end 52, and said first and second distances are substantially equal. As used herein, the phrase “substantially equals” is used to mean that the first and second distances d₁ and d₂ may be identical to one another or differ from one another by less than about 1.0 centimeters (cm).
9. A reversible wheel 10 comprising: two lug bolt plates 1a and 1b spaced from one another, each of said two lug bolt plates 1a and 1b independently comprising three or more lug bolt holes 2a and 2b; and a wheel rim 5 integrally connected to said two lug bolt plates 1a and 1b, said wheel rim 5 comprising an outer rim surface 51 extending from a first rim end 53 to a second rim end 52 opposite said first rim end 53, wherein a first lug bolt plate 1a of said two lug bolt plates 1a and 1b is positioned a first distance d₁ from said first rim end 53 and a second lug bolt plate 1b of said two lug bolt plates 1a and 1b is positioned a second distance d₂ from said second rim end 52, and said first and second distances d₁ and d₂ are substantially equal.
10. The reversible wheel 10 of any one of embodiments 1 to 9, wherein said reversible wheel 10 comprises a single continuous part.
11. The reversible wheel 10 of any one of embodiments 1 to 10, wherein said reversible wheel 10 comprises metal or a composite material.
12. The reversible wheel 10 of any one of embodiments 1 to 11, wherein said reversible wheel 10 comprises aluminum.
13. The reversible wheel 10 of any one of embodiments 1 to 12, wherein said reversible wheel 10 comprises a single continuous part formed solely of aluminum.
14. The reversible wheel 10 of any one of embodiments 1 to 13, wherein said reversible wheel 10 consists of a single continuous part consisting of aluminum.
15. The reversible wheel 10 of any one of embodiments 1 to 11, wherein said reversible wheel 10 comprises a carbon fiber reinforced polymeric material. For example, the polymeric material may comprise a thermoset material (e.g., an epoxy, a polyester, a polyetheretherketone (PEEK), etc.) reinforced with carbon fibers. Further, fibers other than or in addition to the carbon fibers may also be used. Suitable additional fibers include, but are not limited to, glass fibers, nylon fibers, etc.
16. The reversible wheel 10 of any one of embodiments 7 to 15, wherein said wheel rim 5 further comprises at least one valve stem hole 72 positioned along said outer rim surface 51.
17. The reversible wheel 10 of any one of embodiments 7 to 16, wherein said wheel rim 5 further comprises (i) a first valve stem hole 72 positioned along said outer rim surface 51 between said first rim end 53 and said lug bolt plate 1a, and (i) a second valve stem hole 72 positioned along said outer rim surface 51 between said second rim end 52 and said lug bolt plate 1b.
18. The reversible wheel 10 of any one of embodiments 7 to 17, wherein said wheel rim 5 further comprises one or more surface undulations 75 along tire joining areas 51a and 51b of said outer rim surface 51.
19. The reversible wheel 10 of any one of embodiments 7 to 18, wherein said wheel rim 5 further comprises two sets of surface undulations 75 along tire-joining areas 51a and 51b, respectively, of said outer rim surface 51, each set of said surface undulations 75 comprising a plurality of parallel grooves 76 within said outer rim surface 51, each of said parallel grooves 76 extending parallel to said lug bolt plate 1a and said lug bolt plate 1b and forming a circular configuration along said outer rim surface 51.

### Methods of Making Reversible Wheels Embodiments

20. A method of making the reversible wheel 10 of any one of claims 1 to 19, said method comprising: forming a wheel 10 comprising two lug bolt plates 1a and 1b spaced from one another.
21. The method of embodiment 20, wherein said forming step comprises molding one or more wheel components (e.g., a wheel component comprising lug bolt plate 1a and a wheel component comprising lug bolt plate 1b) during a thermoforming step (e.g., an injection molding step or a metal-shaping step).
22. The method of embodiment 20 or 21, wherein said forming step comprises molding two or more separate wheel components (e.g., a wheel component comprising lug bolt plate 1a and a wheel component comprising lug bolt plate 1b) during a thermoforming step (e.g., an injection molding step or a metal-shaping step); and connecting the two or more separate wheel components to one another.
23. The method of embodiment 22, wherein said connecting step comprises a welding step.
24. The method of any one of embodiments 20 to 23, further comprising: drilling two or more lug bolt holes 2a and 2b in each lug bolt plate 1a and 1b.
25. The method of any one of embodiments 20 to 24, further comprising cutting one or more cut-out sections 3a and 3b through each lug bolt plate 1a and 1b, wherein the one or more cut-out sections 3a and 3b of each lug nut plate 1a and 1b provide tool access to lug bolt holes 2a and 2b on an adjacent lug bolt plate 1a or 1b.
26. The method of any one of embodiments 20 to 25, further comprising cutting a single cut-out section 3a and 3b through each lug bolt plate 1a and 1b, wherein the single cut-out section 3a and 3b of each lug nut plate 1a and 1b provides tool access to lug bolt holes 2a and 2b on an adjacent lug bolt plate 1a or 1b.
27. The method of any one of embodiments 20 to 26, further comprising forming one or more valve stem holes 72 in a wheel rim 5 portion of said reversible wheel 10. For example, the one or more valve stem holes 72 may be formed via a molding step or a drilling step.
28. The method of any one of embodiments 20 to 27, further comprising forming two separate valve stem holes 72 in a wheel rim 5 portion of said reversible wheel 10.
29. The method of any one of embodiments 20 to 28, further comprising forming one or more surface undulations 75 along tire joining areas 51a and 51b of a wheel rim 5 portion of said reversible wheel 10.
30. The method of any one of embodiments 20 to 29, further comprising two sets of surface undulations 75 along tire-joining areas 51a and 51b, respectively, of a wheel rim 5 portion of said reversible wheel 10, each set of said surface undulations 75 comprising a plurality of parallel grooves 76 within said tire-joining areas 51a and 51b, each of said parallel grooves 76 extending parallel to said lug bolt plate 1a and said lug bolt plate 1b and forming a circular configuration along said tire joining areas 51a and 51b.

### Methods of Using Reversible Wheels Embodiments

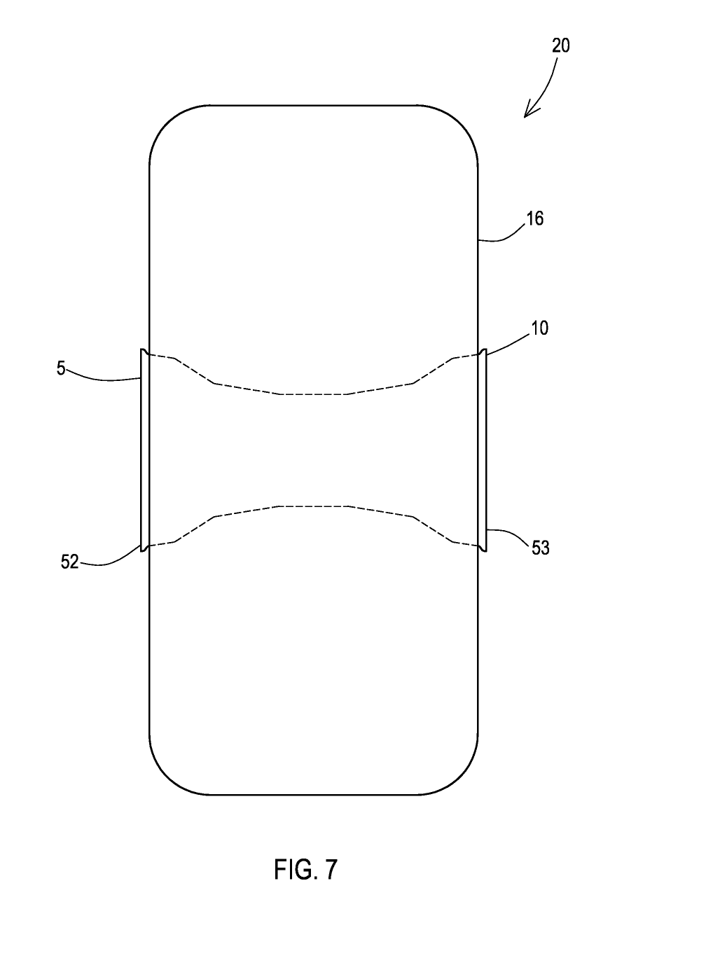

31. A method of using the reversible wheel 10 of any one of embodiments 1 to 19, said method comprising: attaching the reversible wheel 10 to a vehicle (not shown) via one or more lug bolts 4a and 4b and one of the two lug bolt plates 1a and 1b that is closest to the vehicle.
32. A method of using the reversible wheel 10 of any one of embodiments 1 to 19, said method comprising: removing the reversible wheel 10 from a vehicle (not shown) by unscrewing one or more lug bolts 4a or 4b attached to a first lug bolt plate 1a or 1b of said two lug bolt plates 1a and 1b; and re-attaching the reversible wheel 10 to the vehicle via one or more lug bolts 4b or 4a and a second lug bolt plate 1b or 1a of said two lug bolt plates 1a and 1b.
33. The method of embodiment 31 or 32, further comprising: removing a tire 16 (see, FIG. 7) from the reversible wheel 10.
34. The method of any one of embodiments 31 to 33, further comprising: placing a tire 16 onto the reversible wheel 10.
35. The method of any one of embodiments 31 to 34, further comprising: placing a tire 16 onto the reversible wheel 10; and inflating the tire 16.
36. The method of any one of embodiments 31 to 35, wherein the vehicle (not shown) comprises a go-kart.

### Reversible Wheel/Tire Containing Embodiments

37. A tire 16 comprising the reversible wheel 10 of any one of embodiments 1 to 19.
38. A vehicle (not shown) comprising the reversible wheel 10 of any one of embodiments 1 to 19.
39. A go-kart (not shown) comprising the reversible wheel 10 of any one of embodiments 1 to 19.

It should be understood that although the above-described reversible wheels, tires, and methods are described as “comprising” one or more components, features or steps, the above-described reversible wheels, tires, and methods may “comprise,” “consists of,” or “consist essentially of” any of the above-described components and/or features and/or steps of the reversible wheels, tires, and methods. Consequently, where the present invention, or a portion thereof, has been described with an open-ended term such as “comprising,” it should be readily understood that (unless otherwise stated) the description of the present invention, or the portion thereof, should also be interpreted to describe the present invention, or a portion thereof, using the terms “consisting essentially of” or “consisting of” or variations thereof as discussed below.

As used herein, the terms “comprises,” “comprising,” “includes,” “including,” “has,” “having,” “contains”, “containing,” “characterized by” or any other variation thereof, are intended to encompass a non-exclusive inclusion, subject to any limitation explicitly indicated otherwise, of the recited components. For example, a reversible wheel, tire, and/or method that “comprises” a list of elements (e.g., components or features or steps) is not necessarily limited to only those elements (or components or features or steps), but may include other elements (or components or features or steps) not expressly listed or inherent to the reversible wheel, tire, and/or method.

As used herein, the transitional phrases “consists of” and “consisting of” exclude any element, step, or component not specified. For example, “consists of” or “consisting of” used in a claim would limit the claim to the components, materials or steps specifically recited in the claim except for impurities ordinarily associated therewith (i.e., impurities within a given component). When the phrase “consists of” or “consisting of” appears in a clause of the body of a claim, rather than immediately following the preamble, the phrase “consists of” or “consisting of” limits only the elements (or components or steps) set forth in that clause; other elements (or components) are not excluded from the claim as a whole.

As used herein, the transitional phrases “consists essentially of” and “consisting essentially of” are used to define a reversible wheel, tire, and/or method that includes materials, steps, features, components, or elements, in addition to those literally disclosed, provided that these additional materials, steps, features, components, or elements do not materially affect the basic and novel characteristic(s) of the claimed invention. The term “consisting essentially of” occupies a middle ground between “comprising” and “consisting of”.

Further, it should be understood that the herein-described reversible wheels, tires, and/or methods may comprise, consist essentially of, or consist of any of the herein-described components and features, as shown in the figures with or without any additional feature(s) not shown in the figures. In other words, in some embodiments, the reversible wheel, tire, and/or method of the present invention may have any additional feature that is not specifically shown in the figures. In some embodiments, the reversible wheels, tires, and/or methods of the present invention do not have any additional features other than those (i.e., some or all) shown in the figures, and such additional features, not shown in the figures, are specifically excluded from the reversible wheel, tire, and/or method.

The present invention is further illustrated by the following examples, which are not to be construed in any way as imposing limitations upon the scope thereof. On the contrary, it is to be clearly understood that resort may be had to various other embodiments, modifications, and equivalents thereof which, after reading the description herein, may suggest themselves to those skilled in the art without departing from the spirit of the present invention and/or the scope of the appended claims.

### Example 1

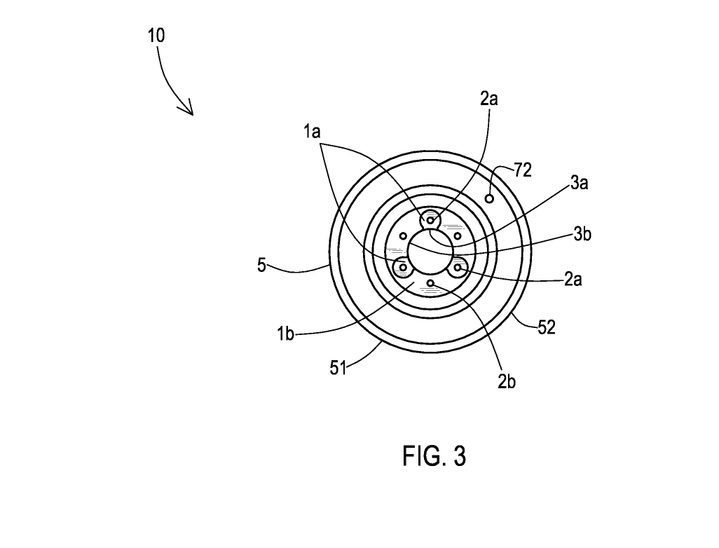

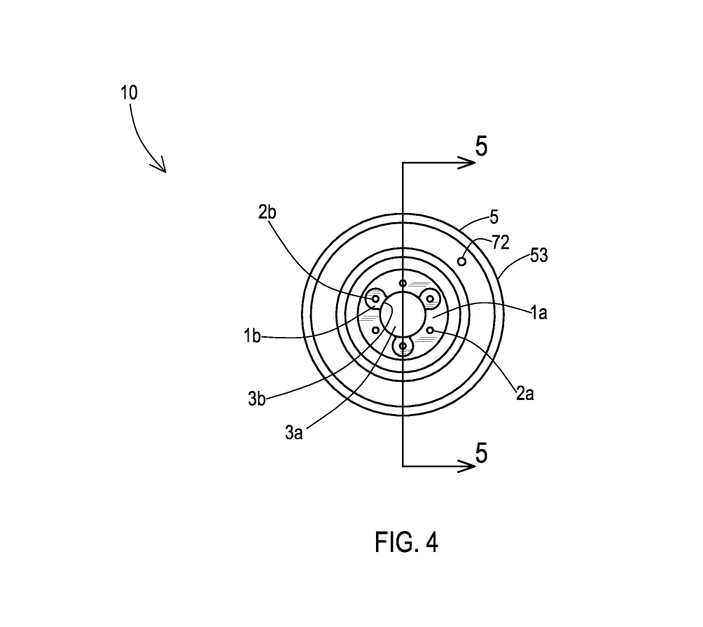

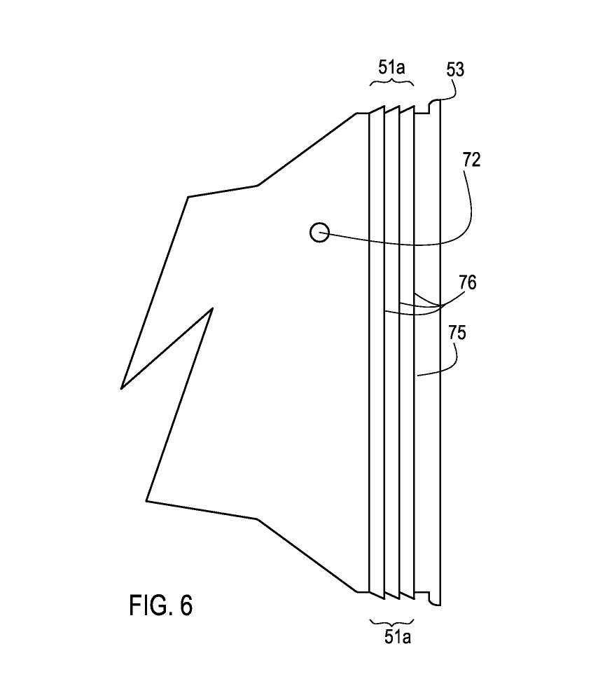

Reversible wheels and tires, similar to exemplary reversible wheel 10 and exemplary tire 16 shown in FIGS. 1-7, were prepared using one or more thermoforming (e.g., molding) and/or shaping and/or machining steps.

From the above disclosure of the general principles of the present invention and the preceding detailed description, those skilled in this art will readily comprehend the various modifications, re-arrangements and substitutions to which the present invention is susceptible. Therefore, the scope of the invention should be limited only by the following claims and equivalents thereof. In addition, it is understood to be within the scope of the present invention that the disclosed and claimed reversible wheels and/or methods may be useful in other applications (i.e., vehicles other than go-karts). Therefore, the scope of the invention may be broadened to include the use of the claimed and disclosed structures for such other applications.

What is claimed is:

1. A reversible wheel comprising:
two lug bolt plates spaced from one another, each of said two lug bolt plates independently comprising two or more lug bolt holes.

2. The reversible wheel of claim 1, wherein each of said two lug bolt plates independently comprises three lug bolt holes.

3. The reversible wheel of claim 1, wherein each of said two lug bolt plates independently comprising one or more cut-out sections so as to provide tool access to said two or more lug bolt holes on a given lug bolt plate.

4. The reversible wheel of claim 3, wherein each of said two lug bolt plates independently comprises a single cut-out section so as to provide tool access to said two or more lug bolt holes on a given lug bolt plate.

5. The reversible wheel of claim 1, wherein each of said two lug bolt plates independently comprises a single cut-out section so as to provide tool access to said two or more lug bolt holes on a given lug bolt plate, said single cut-out section having a symmetrical three-petal clover shape.

6. The reversible wheel of claim 1, wherein each of said two lug bolt plates independently comprises a single cut-out section so as to provide tool access to said two or more lug bolt holes on a given lug bolt plate, wherein said single cut-out section is sized so as to enable positioning of an impact gun component or a ratchet wrench component thru a first lug bolt plate of said two lug bolt plates so as to (i) remove lug nuts from or (ii) secure lug nuts to a second lug bolt plate of said two lug bolt plates.

7. The reversible wheel of claim 1, further comprising a wheel rim integrally connected to said two lug bolt plates, said wheel rim comprising an outer rim surface extending from a first rim end to a second rim end opposite said first rim end.

8. The reversible wheel of claim 1, further comprising a wheel rim integrally connected to said two lug bolt plates, said wheel rim comprising an outer rim surface extending from a first rim end to a second rim end opposite said first rim end, wherein a first lug bolt plate of said two lug bolt plates is positioned a first distance from said first end and a second lug bolt plate of said two lug bolt plates is positioned a second distance from said second end, and said first and second distances are substantially equal.

9. The reversible wheel of claim 1, wherein said reversible wheel comprises a single continuous part.

10. The reversible wheel of claim 1, wherein said reversible wheel comprises metal or a composite material.

11. The reversible wheel of claim 10, wherein said reversible wheel comprises aluminum.

12. The reversible wheel of claim 10, wherein said reversible wheel comprises a carbon fiber reinforced polymeric material.

13. A method of making the reversible wheel of claim 1, said method comprising:
forming a wheel comprising two lug bolt plates spaced from one another; and
drilling two or more lug bolt holes in each lug bolt plate.

14. A tire comprising the reversible wheel of claim 1.

15. A vehicle comprising the reversible wheel of claim 1.

16. A go-kart comprising the reversible wheel of claim 1.

17. A method of using the reversible wheel of claim 1, said method comprising:
removing the reversible wheel from a vehicle by unscrewing one or more lug bolts attached to a first lug bolt plate of the two lug bolt plates; and
re-attaching the reversible wheel to the vehicle via one or more lug bolts and a second lug bolt plate of the two lug bolt plates.

18. A reversible wheel comprising:
two lug bolt plates spaced from one another, each of said two lug bolt plates independently comprising three or more lug bolt holes; and
a wheel rim integrally connected to said two lug bolt plates, said wheel rim comprising an outer rim surface extending from a first rim end to a second rim end opposite said first rim end,
wherein a first lug bolt plate of said two lug bolt plates is positioned a first distance from said first end and a second lug bolt plate of said two lug bolt plates is positioned a second distance from said second end, and said first and second distances are substantially equal.

19. The reversible wheel of claim 18, wherein said reversible wheel comprises a single continuous part formed solely of aluminum.

20. The reversible wheel of claim 18, wherein said reversible wheel consists of a single continuous part consisting of aluminum.
